(19) United States
(12) Patent Application Publication
(10) Pub. No.: US 2015/0188890 A1
(43) Pub. Date: Jul. 2, 2015

(54) CLIENT SIDE ENCRYPTION IN ON-DEMAND APPLICATIONS

(71) Applicants: BARE SAID, Sankt Leon (DE); Peter Eberlein, Malsch (DE)

(72) Inventors: BARE SAID, Sankt Leon (DE); Peter Eberlein, Malsch (DE)

(21) Appl. No.: 14/140,537

(22) Filed: Dec. 26, 2013

(51) Int. Cl. H04L 29/06

(52) U.S. Cl. CPC H04L 63/0428

(57) ABSTRACT

A client side encryption for on-demand applications is described. The encryption is targeted to the business object attributes flagged as critical in the application metadata repository. This approach is applicable to a wide range of enterprise applications that are provided on-demand in the cloud and makes them attractive to security sensitive customers.

### BACKGROUND

Software as a service (SaaS), also referred to as “on-demand software” is a software delivery model, in which software and associated data are centrally hosted on the cloud. SaaS is typically accessed by customers using a thin client via a web browser. SaaS has become a common delivery model for many enterprise applications and has been incorporated into the strategy of all leading enterprise software companies.

There is a general trend to move applications to the cloud. However, this trend is hampered by security concerns. Some users prefer cloud solutions provided by large software providers that are regarded as reliable partners. For certain user segments, cloud solutions are still not an option, because even the largest cloud provider might get hacked and this could affect their customers in a very negative aspect if confidential data gets exposed.

For on-demand applications, the trend so far is to encrypt the complete database, where the on-demand application stores the data. However, the application server. running in the cloud, needs to be able to access this database in order to work. So the application server encrypts but also decrypts the data in order to operate with it. The data is decrypted in the memory in the cloud and this unencrypted data is vulnerable. Thus, while the database might be secured from direct database attacks, the on-demand application is still vulnerable.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood front the following detailed description taken in conjunction with the accompanying drawings.

FIG. 1 is a block diagram illustrating an architecture overview.

FIG. 2 is a flow diagram illustrating an embodiment of a method tor client side encryption in on-demand applications.

FIG. 3 is a block diagram illustrating an embodiment of a system for client side encryption in on-demand applications.

FIG. 4 is a block diagram illustrating an embodiment of a computing environment in which the techniques described for client side encryption in on-demand applications can be implemented.

### DETAILED DESCRIPTION

Embodiments of techniques for client side encryption in on-demand applications are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Real world objects, for example an employee or a sales order, may be modeled as business objects in business application systems. Business objects may be visualized as “black boxes” that encapsulate data and business processes, thus hiding the details of the structure and implementation of the underlying data. An object type may describe the features common to all instances of that object type. This includes information such as the unique name of the object type, its classification, and the data model. An attribute of a business object may contain data about the business object, thus describing a particular object property. For example, “Employee.Name” may be an attribute of the “Employee” object type.

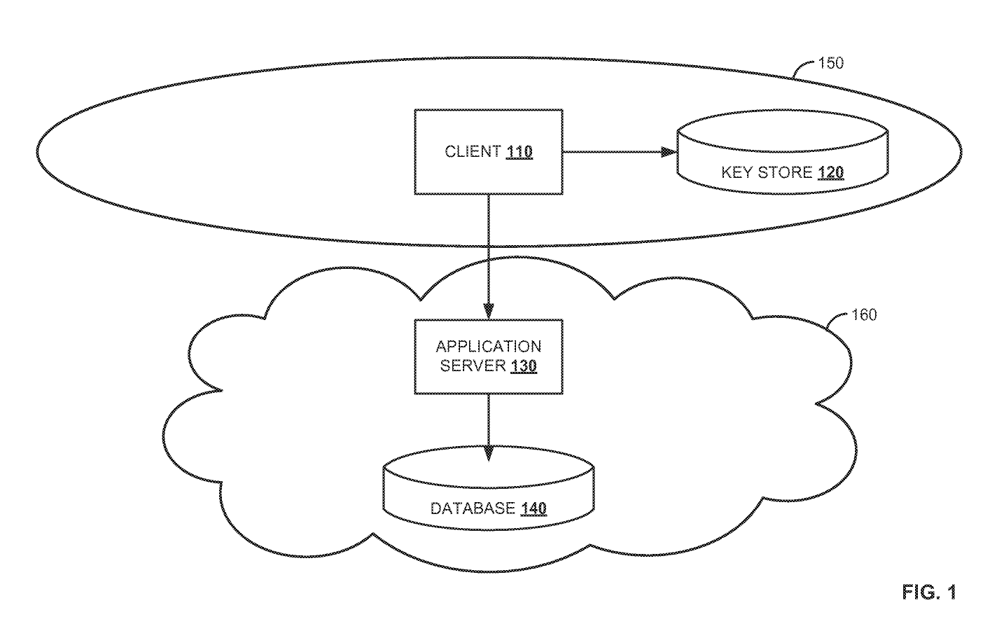

FIG. 1 illustrates an architecture overview of a system landscape in the cloud. What is described is encryption of data on business object attribute level on the client side and transmitting and storing the encrypted fields in an unencrypted database 140. In this way, the business application, hosted at application server 130 in the cloud 160, accesses encrypted data, which does not imply any additional security measures for protection. Encryption and decryption of these fields may be done completely on the user interface level at the client 110 in the client network 150 using a symmetrical encryption key that may be accessed front a company internal Key Store 120 and never leaves the client network 150. When a client 110 sends an attribute to the business application that is flagged as critical, it encrypts the data with a symmetrical encryption key before actually sending it. When a client 110 receives an attribute flagged as critical, it decrypts the data before displaying it in the user interface.

A flag indicating if an attribute is critical or not, allows selective encryption of individual fields in business objects. It is important to minimize the performance overhead and restrictions introduced by encryption. The critical flag may be stored in the business application metadata repository on the level of business object data types, ensuring that different business objects related to each other via a common attribute both encrypt the attribute or none of them, so that relations still work independent on encryption.

For simple text fields, such as a product description, this approach works. Challenges may appear with other data types or different usage than storing and retrieving data. For example, searches, dates and ranges, aggregation, and numbers are such data types.

In one embodiment, searching text works fine for encrypted attributes if frill strings are compared to each other. The client 110 encrypts the search term in the same way as encrypted attributes and the business application compares the encrypted data strings. If they match, the encrypted text strings also match.

In one embodiment, to provide a search-as-you-type feature or matching on identical prefixes, an advanced approach may be used. Each text attribute that should support these features is stored not just encrypted as full text string, but also the encrypted substrings for the first character, the first two characters, the first three characters and so on. All encrypted variants of the attribute are sent to the business application, where they are stored in a table that supports this kind of search by having a dedicated column for each number of characters and one for the full text string. When performing a search, the client 110 sends an encrypted search string together with the number of characters to the business application and the search table is matched on t e corresponding column for the number of provided characters.

In one embodiment, dates are stored in separate fields in the database 140 for day, month, and year. For an exact match of a specific date these three values are compared with the values of the date requested by a client 110. In order to enable selections based on date ranges, no simple string comparison can be performed, because these date strings are encrypted and therefore have a different ordering than the unencrypted date strings. Therefore, a SELECT . . . IN . . . statement may be performed for each date component with all values from this range in their encrypted form. For example, to select all business objects dated between March 3 and May 5 in 2012, the SELECT statement may look like (all values in their encrypted form): SELECT WHERE (day IN 3,4,5, . . . 31 AND month=3 AND year=2012) OR (month=4 AND year=2012) OR (day IN),2,3,4,5 AND month=5 AND year=2012).

In one embodiment, a similar approach as for dates can be followed for aggregations, For example, if a business object has an attribute for country and the client performs a search for a continent, then the actual search queries for all countries of this continent. To keep the mapping between countries and continents (or any other aggregation) consistent, it is stored centrally in the business application. If the client 110 needs to expand a continent into its countries, it reads this flapping table and performs the encryption on each country of the continent it is looking for. Assuming that this mapping table itself is not encrypted, it is important that in this situation, the client 110 reads the full mapping table and not just the entries for the one continent it is actually looking for, so that on the server side 130 the actual query parameters cannot be concluded from the previous look up from the mapping table. Otherwise, the query of the countries for one specific continent in plain text, followed by an encrypted query with the same number of countries would reveal the continent although the countries themselves are encrypted in the second query because of the close correlation of these two queries. By reading the full mapping table in a first (unencrypted) query, it remains secret which entries of the result set have been used to create the second (encrypted) query. An example of a mapping table is presented in Table 1 below:

TABLE 1

| Continent | Country |
|---|---|
| Europe | Germany |
| Europe | France |
| Europe | Italy |
| Europe | . . . |
| Asia | China |
| Asia | . . . |

If the client 110 wants to find all business objects related to Europe but this object contains an encrypted field for country, the client retrieves the mapping table above, filters the entries by the statement WHERE continent=Europe and encrypts all countries from the result set (in the example Table 1 above: Germany, France, Italy, . . . ). Then the following query to the business application is executed: SELECT WHERE country IN encrypt(Get many), encryp((France), encrypt(Italy), . . . .

In this way the business application has no access of the unencrypted countries but a list of encrypted fields that can be matched to the corresponding business object fields in the business application database 140.

In one embodiment, in case numbers are stored and retrieved, no special consideration is used. However, numbers are often used as a basis for calculations. For example, if an item price is $4.20 and its quantity is 5, then the total amount is $21.00. Because calculations cannot be performed on encrypted numbers, they may be done on the client side. For simple calculations like in the example above, such calculations may be performed by a calculation engine embedded in the client 110. When the client 110 receives an attribute that is a calculated field, this attribute contains a calculation rule and not an actual number. For the example above, the attribute “total_amount” contains the rule “item_price”*“quantity”.

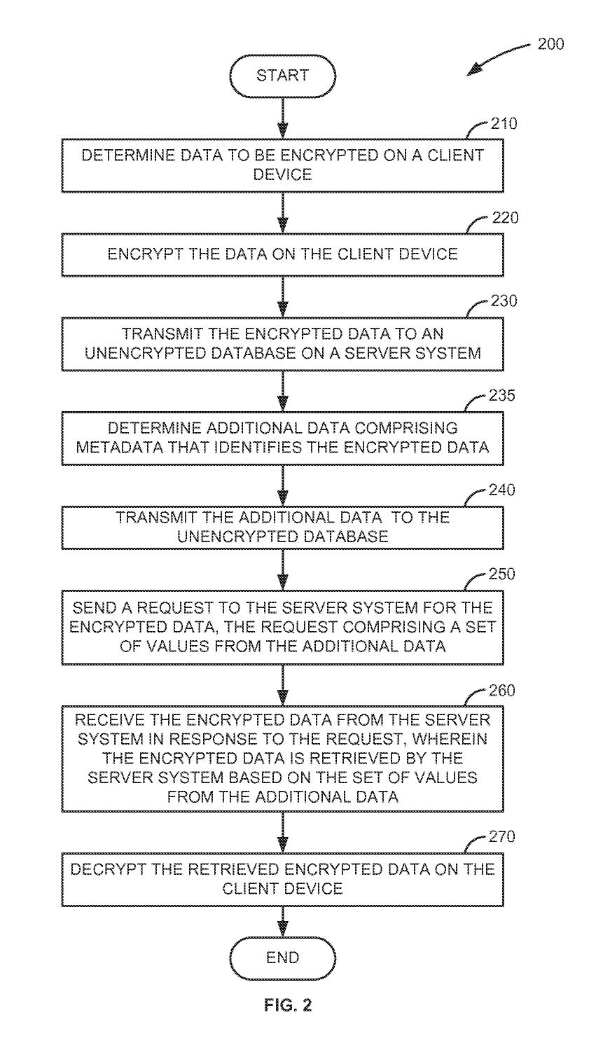

FIG. 2 is a flow diagram illustrating an embodiment of a process 200 for client side encryption in on-demand applications, At 210, data to be encrypted on a client device is determined, The data to be encrypted may comprise business object attribute data. The data to be encrypted may be sensitive data that may need prevention from exposure. The data to be encrypted may be marked with a flag for encryption,

At 220, the data is encrypted on the client device. The encryption variant may nut be important, but the encryption should be performed on the client device with an encryption key accessible internally within the client's network such as from the Key Store 120 in FIG. 1.

Turning back to FIG. 2, at 230, the encrypted data is transmitted to an unencrypted database on a server system. For example, the database may be such as database 140 in FIG. 1.

At 235, additional data is determined. The additional data may comprise metadata to identify the encrypted data. Because the data is encrypted, it cannot be retrieved by querying it in a typical way, rather the additional data, relevant to the encrypted data, is used for retrieving the encrypted data.

Referring again to FIG. 2, at 240, the additional data is transmitted to the unencrypted database.

In one embodiment, the additional data includes encrypted search substrings of a search string from a table of search strings. When a client starts typing, the typed characters are matched with a respective column of the table and all strings that are within the respective column are used for deriving the relevant data, which is returned encrypted to the client. Then, on the client device, the data is decrypted.

In one embodiment, the additional data includes dates stored in encrypted form to provide searching by date ranges via transforming a searched date range to all values in the searched date range in their encrypted form.

In one embodiment, the additional data includes fields from a mapping table to provide searching within aggregations.

In one embodiment, the additional data includes encrypted numbers to provide searching for ranges of values.

Turning back to FIG. 2, at 250, a request for the encrypted data is sent to the server system. The request includes a set of values from the additional data.

At block 260, the encrypted data in response to the request is received. The requested encrypted data is retrieved by the server system based on the set of values from the additional data.

At block 270, the retrieved encrypted data is decrypted on the c rent device.

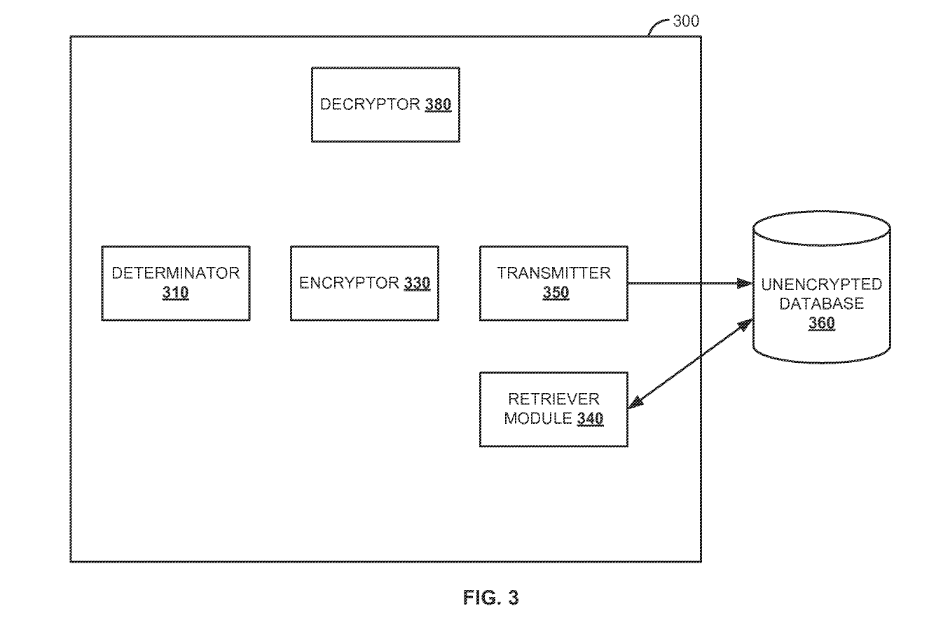

FIG. 3 is a block diagram illustrating an embodiment of a system 300 for client side encryption in on-demand applications. The system 300 includes a determinator 310, an encryptor 330, a transmitter 350, and a retriever module 340.

The determinator 310 is operable to determine data to be encrypted on a client device. The data to be encrypted may comprise business object attribute data. The data to be encrypted may be sensitive data that may need prevention from exposure. The data to be encrypted may be marked with a flag for encryption. The determinator module 310 is also operable to determine additional data. The additional data may comprise metadata to identify the encrypted data. Because the data is encrypted, it cannot be retrieved by querying it in a typical way, rather the additional data, relevant to the encrypted data, is used for retrieving the encrypted data.

The encryptor 330 is operable to encrypt the data on the client device. The encryption variant may be various, but the encryption has to be performed on the client device with an encryption key accessible internally within the client's network such as from the Key Store 120 in FIG. 1.

The transmitter 350 is operable to transmit the encrypted data to an unencrypted database 360 on a server system. The transmitter 350 is further operable o transmit the additional data to the unencrypted database 360.

In one embodiment, the additional data includes encrypted search substrings of a search string from a table of search strings. When a client starts typing, the typed characters are matched with a respective column of the table and all strings that are within the respective column are used for deriving the relevant data, which is returned encrypted to the client. Then, on the client device, the data is decrypted.

In one embodiment, the additional data includes dates stored in encrypted form to provide searching by date ranges via transforming a searched date range to all values in the searched date range in their encrypted form.

In one embodiment, the additional data includes fields from a mapping table to provide searching within aggregations.

In one embodiment, the additional data includes encrypted numbers to provide searching for ranges of values.

The retriever module 340 is operable to send a request for the encrypted data to the unencrypted database 360, the request comprising a set of values from the additional data. The retriever module is also operable to receive the encrypted data from the unencrypted database 360 in response to the request, wherein the encrypted data is retrieved by the server system based on the set of values from the additional data.

In one embodiment the system 300 includes a decryptor 380 to decrypt the retrieved encrypted data on the client device.

Some embodiments may include the above-described methods being written as one Of more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments may include remote procedure calls being used to implement one or more of these components across a distributed programming environment. For example, a logic level may reside on a first computer system that is located remotely from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

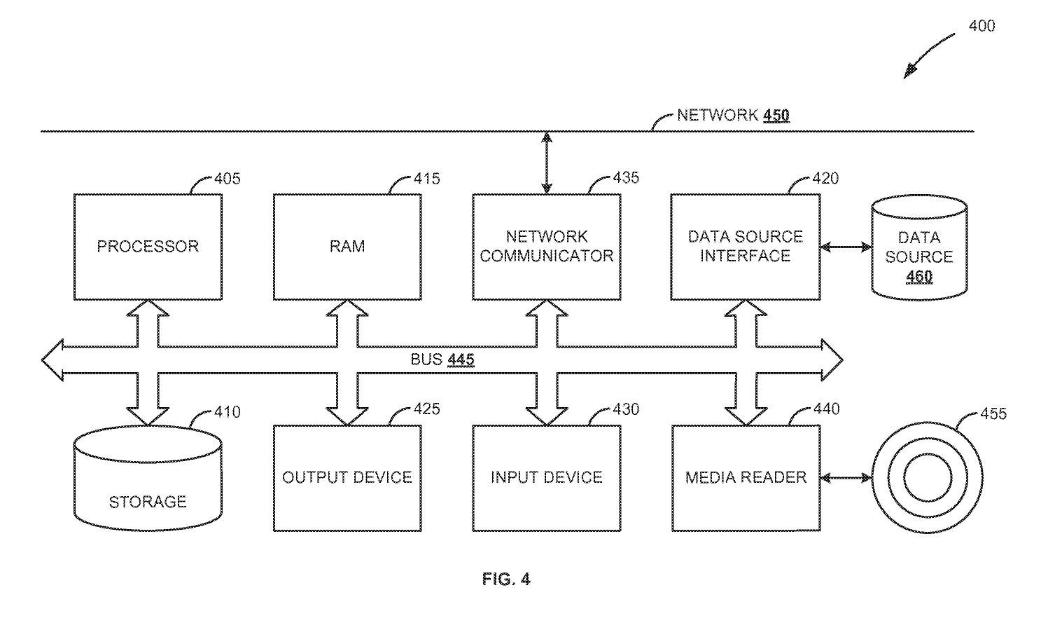

FIG. 4 is a block diagram of an exemplary computer system 400. The computer system 400 includes a processor 405 that executes software instructions or code stored on a computer readable storage medium 455 to perform the above-illustrated methods. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment, the computer system 400 further includes an output device 425 (e.g., a display) to provide at least some of the results of the execution as output including, but not limited to, visual information to users and an input device 430 to provide a user or another device with means for entering data and/or otherwise interact with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In sonic embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), tiles, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments and examples are described herein for illustrative purposes, various equivalent modifications are possible, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method, at a server system having one or more processors and memory storing one or more programs to be executed by the one or more processors:
receiving encrypted data, wherein the encrypted data comprises business object attribute data;
receiving additional data comprising metadata that includes information identifying the encrypted data;
receiving a request for the encrypted data, the request comprising a set of values from the additional data;
retrieving the encrypted data in the unencrypted database based on the set of values; and
providing the retrieved encrypted data in response to the request.

2. The method of claim 1, wherein the additional data comprises encrypted search substrings of a search string from a table of search strings,

3. The method of claim 1, wherein the additional data comprises dates stored in encrypted form to provide searching by date ranges via transforming a searched date range to all values in the searched date range in their encrypted form.

4. The method of claim 1, wherein the additional data comprises fields from a mapping table to provide searching within aggregations.

5. The method of claim 1, wherein the additional data comprises encrypted numbers to provide searching for ranges of values.

6. The method of claim 1, wherein the retrieved encrypted data is provided to a client device.

7. The method of claim 6, wherein the provided encrypted data is decrypted at the client device.

8. A computer system for encryption in applications on a client device, comprising:
a processor; and
a memory in communication with the processor, the memory storing instructions related to:
a determinator to:
determine data to he encrypted on the client device, wherein the data comprises business object attribute data; and
determine additional data, wherein the additional data comprises metadata that identifies the encrypted data;
an encryptor to encrypt the data on the client device;
a transmitter to:
transmit the encrypted data to an unencrypted database on a server system; and
transmit the additional data to the unencrypted database on the server system;
a retriever module to:
send a request to the server system for the encrypted data, the request comprising a set of values from the additional data; and
receive the encrypted data from the server system in response to the request, wherein the encrypted data is retrieved by the server system based on the set of values from the additional data.

9. The system of claim 8, wherein the additional data comprises encrypted search substrings of a search string from a table of search strings.

10. The system of claim 8, wherein the additional data comprises dates stored in encrypted form to provide searching by date ranges via transforming a searched date range to all values in the searched date range in their encrypted form.

11. The system of claim 8, wherein the additional data comprises fields from a mapping table to provide searching within aggregations.

12. The system of claim 8, wherein the additional data comprises encrypted numbers to provide searching for ranges of values.

13. The system of claim 8, further comprising a decryptor to decrypt the retrieved encrypted data on the client device.

14. An article of manufacture including a non-transitory computer readable storage medium to tangibly store instructions, which when executed by a computer, cause the computer to:
determine data to be encrypted on a client device, wherein the data comprises business object attribute data marked with a flag for encryption;
encrypt the data on the client device;
transmit the encrypted data to an unencrypted database on a server system;
determine additional data, wherein the additional data comprises metadata that identifies the encrypted data;
transmit the additional data to the unencrypted database on the server system;
send a request to the server system for the encrypted data, the request comprising a set of values from the additional data; and
receiving the encrypted data from the server system in response to the request, wherein the encrypted data is retrieved by the server system based on the set of values from the additional data.

15. The article of manufacture of claim 14, wherein the additional data comprises encrypted search substrings of a search string from a table of search strings.

16. The article of manufacture of claim 14, wherein the additional data comprises dates stored in encrypted form to provide searching by date ranges via transforming a searched date range to all values in the searched date range in their encrypted form.

17. The article of manufacture of claim 14, wherein the additional data comprises fields from a mapping table to provide searching within aggregations.

18. The article of manufacture of claim 14, wherein the additional data comprises encrypted numbers to provide searching for ranges of values.

19. The article of manufacture of claim 14, further comprising instructions to decrypt the retrieved encrypted data on the client device.
